(19) United States
(12) Patent Application Publication
(10) Pub. No.: US 2018/0070087 A1
(43) Pub. Date: Mar. 8, 2018

(54) METHOD FOR BROWSING A COLLECTION OF VIDEO FRAMES AND CORRESPONDING DEVICE

(71) Applicant: THOMSON Licensing, Issy-les-Moulineaux (FR)

(72) Inventors: Matthieu FRADET, Chanteloup (FR); Claire-Helene DEMARTY, MONTREUIL LE GAST (FR); Lionel OISEL, La Nouaye (FR)

(21) Appl. No.: 15/553,803

(22) PCT Filed: Mar. 3, 2016
(86) PCT No.: PCT/EP2016/054592

§ 371 Date: Aug. 25, 2017

(30) Foreign Application Priority Data
Mar. 4, 2015 (EP) 1530532.7

(51) Int. Cl. H04N 19/132; G11B 27/34; G11B 27/10; H04N 19/107

(52) U.S. Cl. CPC H04N 19/132; H04N 19/107; G11B 27/102; G11B 27/34

(57) ABSTRACT

The invention relates to a method for browsing a collection of P video frames through a user interface comprising N cells disposed along a time line with N<P. The method comprises the steps of: —determining (S1) a subset of N key frames by uniformly subsampling the collection of P video frames, —displaying (S2) the N key frames in the N cells according to a chronological order, the N cells being classified as current cell, past cells and future cells, —receiving (S3) an input command requesting to transfer a selected key frame displayed in a cell Ci to a cell Cj of the UI, —in response to the input command, updating (S4) the key frame displayed in the cell Cj by the selected key frame and updating accordingly the key frames displayed in the other cells by updating key frames while maintaining the chronological order of the key frames in the N cells and adjusting the subsampling interval by pieces.

### 1. TECHNICAL FIELD

The present invention relates generally to the field of video browsing. The invention concerns a method for browsing video frames in a timeline user interface.

### 2. BACKGROUND ART

Timeline user interfaces are classically used for browsing collections of video frames. Such a timeline user interface is generally embedded in video players, video editing software or video summarizing software. In these user interfaces, the video frames are displayed in their chronological order and they introduce the notions of current frame, past frames (left side of the current frame) and future frames (right side of the current frame).

The layouts (designs) of these timeline user interfaces may be basically classified into two categories: 1-D layouts and 2-D layouts.

The 1-D layout comprises generally a horizontal timeline whose left end is associated to the start of the video sequence and the right end is associated to the end of the video sequence. Classic video players, such as the one illustrated by FIG. 1, present a simple horizontal scrollbar with a cursor that depicts current instant. One drawback of this representation is that, except the shown current frame and the relative position of the cursor to the start and the end, the user has no information about the rest of the sequence. Sometimes, as illustrated by FIG. 2, as your mouse flies over the timeline, the thumbnail of the corresponding video instant is shown.

As other 1-D horizontal layouts, key-frame filmstrips as illustrated by FIG. 3 (reproduced from Barnes et al. Siggraph2010) present a horizontal image strip in which key-frames are stacked horizontally in a chronological order. Therefore, in order to watch the video from any key-frame, one just needs to click on it. Video Tapestries as illustrated by FIG. 4 (from Barnes et al. Siggraph2010) also exist and create a strip continuous in the spatial domain. In these tapestries, hard borders between discrete moments in time are removed to create a seamless composition.

For both key-frames filmstrips and tapestries, the length of strip is generally much greater than the user's screen width. So the user cannot have a global overview of the whole video sequence on a single screen. The user can view the whole strip, piece by piece, by dragging the strip to make visible another time range, or by tuning the step of the time subsampling of the displayed key-frames.

Tapestries and key-frame filmstrips only exploit the width of the user's screen but not the height. Such representations do not allow a global overview of the video sequence. So 2-D layouts have been developed in order to exploit the two dimensions (width and height) of the user's screen.

FIGS. 5a-5c illustrates examples of 2-D layouts: a book layout, a diagonal layout and a spiral layout. In the book layout (FIG. 5a) and the diagonal layout (FIG. 5b), the timelines are discontinuous, like broken lines. The book layout is often the one chosen for scene chapter selection in a DVD. Spiral layout (FIG. 5c) is generally used to depict the past of an evolving story. Generally, the first video frame of the video sequence is set at the center of the spiral and the current video frame is set at the other (outermost) end of the spiral. The video frames subsequent to the current video frame are not visible.

FIG. 6 illustrates another 2-D layout disclosed in the patent application GB 2 461 757. In this figure, the video frames of a video sequence are sequentially positioned along a path formed of two spirals. The video frame displayed at junction point between the two spirals is the most visible since it has the biggest size. The video frames move in sequence along the path in response to an input command to the system. With this layout, the user may view a plurality of video frames simultaneously. At the same time, the user is able to command the system to move the video frames in sequence along the path and so may bring an image of interest to a point (junction point) along the path where it may be examined more closely.

This system is configured to allow the user to scroll through the video frames. More specifically, it may be configured to move (fast forward or rewind) the video frames along the path by dragging a video frame to the left or to the right.

This layout is adapted to display consecutive video frames of a video sequence. When the video sequence, for example a movie, comprises a large amount of video frames, these latter can not be all displayed in the path. It is not adapted to zoom-in or zoom-out in some parts of the video sequence.

### 3. SUMMARY OF INVENTION

There is thus a need to propose enhanced browsing solutions that would enable to have an overview of the whole video sequence by displaying key frames representative of the whole video sequence and would enable the user to zoom-in or zoom-out easily on some part of the video sequence.

The present invention concerns a method for browsing a collection of P video frames through a user interface, wherein each video frame has a timestamp and wherein the user interface comprises N cells disposed along a time line with N<P, said method comprising the steps of:
determining a subset of N key frames among the collection of video frames by subsampling the collection of P video frames with a first subsampling interval,
displaying the N key frames in the N cells of the user interface according to a chronological order, one of the N cells being defined as a current cell and the cells before and after the current cell along the time line being called past cells and future cells respectively,
receiving an input command requesting to transfer a selected key frame displayed in a cell Cᵢ to a cell Cⱼ of the user interface, the cells Cᵢ and Cⱼ being distinct,
in response to the input command, updating the key frame displayed in the cell Cⱼ by the selected key frame and updating the key frames displayed between the first cell and the cell Cⱼ by subsampling the collection of video frames comprised between the first frame and the selected key frame with a second subsampling interval and updating the key frames displayed between the cell Cⱼ and the last cell by subsampling the collection of video frames between the selected key frame and the last frame with a third subsampling interval.

Hence, according to the invention, a subset of N key frames representative of the collection is first displayed in the cells of the user interface. Then, the user can stretch (zoom-in) or compress (zoom-out) a portion of the displayed collection by moving a selected key frame displayed in a given cell to another cell thus adjusting the uniform subsampling step by piece. According to the invention, the zoom-in or zoom-out is fully customizable by selecting appropriately the cells Cᵢ and Cⱼ.

According to a particular embodiment, in response to the input command, if the cells Cᵢ and Cⱼ are both past cells, only the key frames displayed in the past cells and the current cell are updated and if the cells Cᵢ and Cⱼ are both future cells, only the key frames displayed in the future cells and the current cell are updated.

According to another embodiment, in response to the input command, the key frames displayed in all cells are updated, except possibly the first cell and the last cell.

Thus, if the user moves the key frame of the cell Cᵢ to the cell Cⱼ with j>i, it will result in stretching (zooming-in) the portion of the collection displayed in the cells disposed along the time line before the cell Cⱼ while compressing (zooming-out) the portion of the collection displayed in the cells disposed along the time line after the cell Cⱼ. Conversely, if the user moves the key frame of the cell Cⱼ to the cell Cᵢ, it will result in compressing (zooming-out) the portion of the collection displayed in the cells disposed along the time line before the cell Cⱼ while stretching (zooming-in) the portion of the collection displayed in the cells disposed along the time line after the cell Cⱼ.

According to a particular embodiment, the collection of frames is a video sequence.

According to a particular embodiment, the N key frames displayed in the N cells are determined by subsampling the video sequence.

According to a particular embodiment, the temporal distance between two key frames displayed in two consecutive cells is substantially constant. In this case, the subsampling step is fixed.

According to a particular embodiment, the N key frames displayed in the N cells are determined by:
selecting a key frame of the collection to be placed into the current cell, and
subsampling the portion of the video sequence preceding the selected key frame and subsampling a portion of the video sequence subsequent to the selected key frame in order to determine N−1 updating key frames to be displayed in the past cells and the future cells.

According to a particular embodiment, the temporal distance between two frames displayed in two consecutive cells of the past cells or the future cells is substantially constant. The subsampling step for determining the key frames of the past cells may be different from the subsampling step for determining the key frames of the future cells.

According to a particular embodiment, in response to the input command, the updating key frames are determined by subsampling a portion of the video sequence preceding the key frame displayed in the cell Cᵢ and subsampling a portion of the video sequence subsequent to the key frame displayed in the cell Cᵢ.

According to another embodiment, the N key frames displayed in the N cells are determined by selecting N key frames in the video sequence according to a predetermined selection criterion. This selection may be based on saliency criterion or on the presence of faces, cuts or shots in the video sequence.

In this embodiment, the N key frames are advantageously selected among Q key frames determined according said predetermined selection criterion, with N<Q<P, and, when a transfer of a key frame from a cell Cᵢ to a cell Cⱼ is requested, the updating key frames are selected among the Q frames.

According to a particular embodiment, the updating key frames are determined by firstly selecting key frames among the key frames previously displayed in the N cells and, when appropriate, adding intermediate key frames issued from the collection of video frames.

According to a particular embodiment, the user interface comprises N=2M+1 cells, one cell for the current cell, M cells for the past cells and M cells for the future cells.

According to a particular embodiment, the cells are disposed along the time line such the first M cells defines a first spiral of cells and the last M cells defines a second spiral of cells, said first and second spirals of cells being linked to both sides of the current cell.

According to a particular embodiment, the collection of video frames is a collection of reference frames, each reference frame being representative of a own video sequence having a creation date, said creation date being used as timestamp for the reference frame.

The invention also concerns a processing device for browsing a collection of P video frames through a user interface, wherein each video frame has a timestamp and wherein the user interface comprises N cells disposed along a time line with N<P, said processing device comprising a processor for processing said P video frames, a display element for displaying said user interface, an input circuit for receiving input commands, the processor being configured to:
determine a subset of N key frames among the collection of P video frames by subsampling the collection of P video frames with a first subsampling interval,
display, on the screen element, the N video frames in the N cells of the user interface according to a chronological order, one of the N cells being defined as a current cell and the cells before and after the current cell along the time line being called past cells and future cells respectively,
receive, from the input circuit, an input command requesting to transfer a selected video frame displayed in a cell Cᵢ to a cell Cⱼ of the user interface, the cells Cᵢ and Cⱼ being distinct,
in response to the input command, update the video frame displayed in the cell Cⱼ by the selected video frame and update the video frames displayed between the first cell and the cell Cⱼ by subsampling the collection of video frames comprised between the first frame and the selected key frame with a second subsampling interval and updating the key frames displayed between the cell Cⱼ and the last cell by subsampling the collection of video frames between the selected key frame and the last frame with a third subsampling interval.

### 4. BRIEF DESCRIPTION OF THE DRAWINGS

The invention can be better understood with reference to the following description and drawings, given by way of example and not limiting the scope of protection, and in which:

FIG. 1 is a screen capture illustrating a user interface with a scrollbar;

FIG. 2 is a screen capture illustrating a video player wherein a thumbnail of a video frame of a given instant is displayed above the time line when the user points this instant in the time line;

FIG. 3 is a screen capture illustrating a user interface with key frame filmstrip, reproduced from Barnes et al. Siggraph 2010;

FIG. 4 is a screen capture illustrating a user interface with a video tapestry, reproduced from Barnes et al. Siggraph 2010;

FIGS. 5a to 5c illustrate examples of time line layouts;

FIG. 6 is a schematic view of a time line including two spirals;

FIG. 7 is a schematic view of a time line user interface used for implementing the method according to the invention;

FIG. 8 is a flow chart showing the steps of method according to the invention;

FIG. 9 illustrates the step of displaying key frames in cells disposed along the time line of the user interface;

FIG. 10 illustrates a first example of input command for modifying the key frames displaying in the cells;

FIG. 11 illustrates an update operation of the key frames in cells of the user interface in response to the input command of FIG. 10;

FIG. 12 illustrates a second example of input command for modifying the key frames displaying in the cells;

FIG. 13 illustrates an update operation of the key frames in cells of the user interface in response to the input command of FIG. 12;

FIG. 14 illustrates a third example of input command for modifying the key frames displaying in the cells;

FIG. 15 illustrates an update operation of the key frames in cells of the user interface in response to the input command of FIG. 14;

FIG. 16 illustrates a fourth example of input command for modifying the key frames displaying in the cells;

FIG. 17 illustrates an update operation of the key frames in cells of the user interface in response to the input command of FIG. 16;

FIG. 18 illustrates another example of update operation according to the invention; and

FIG. 19 is an exemplary architecture of a computer system implementing the method of the invention.

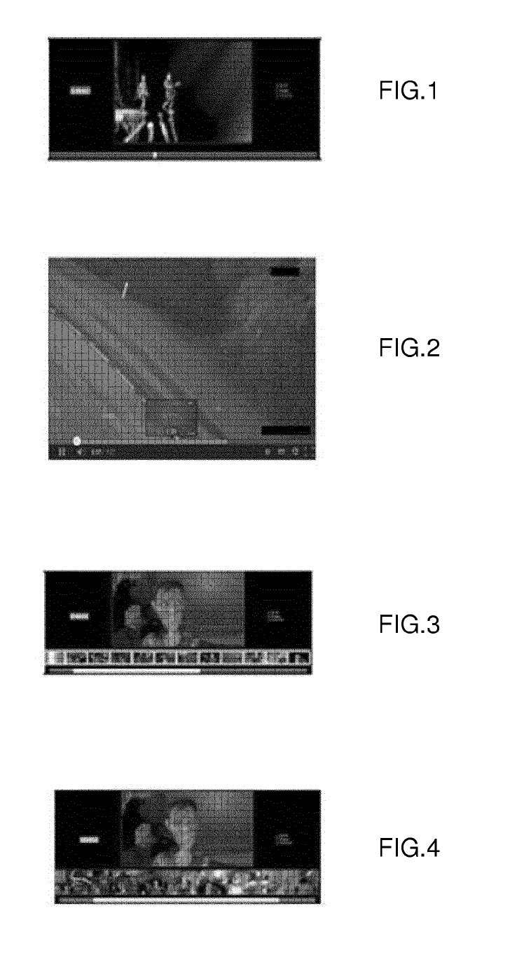

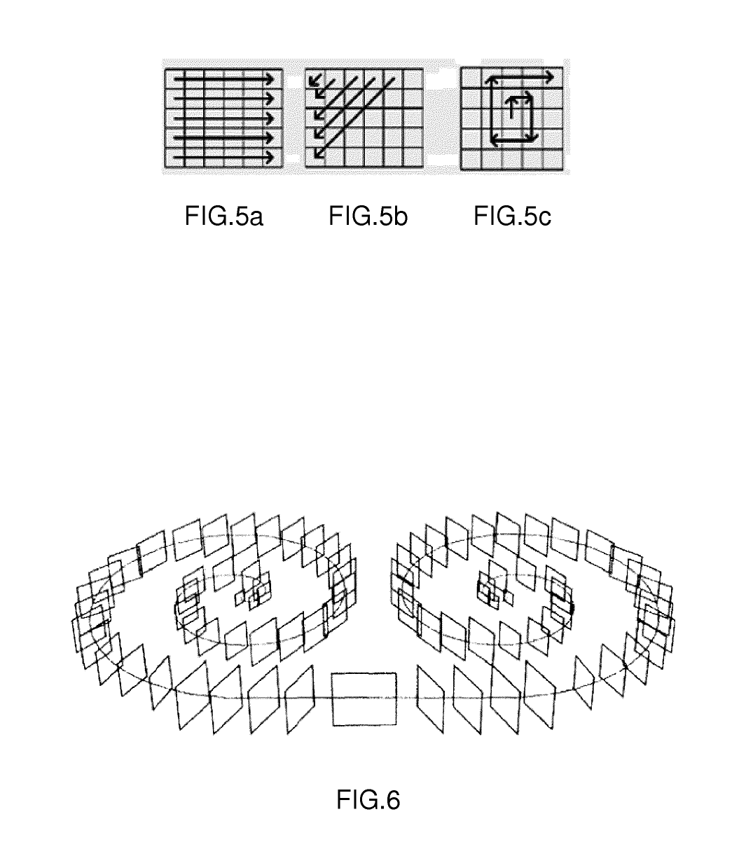

### 5. DESCRIPTION OF EMBODIMENTS

While example embodiments are capable of various modifications and alternative forms, embodiments thereof are shown by way of example in the drawings and will herein be described in details. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Methods discussed below, some of which are illustrated by the drawings, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks. Specific structural and functional details disclosed herein are merely representative for purposes of describing example embodiments of the present invention. This invention may, however, be embodied in many alternate forms and should not be construed as limited to only the embodiments set forth herein.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,” “includes” and/or “including”, when used herein, specify the presence of stated features, integers, steps, operations, elements and/or components, but do not preclude the presence or addition of one or more other features, integers, steps, operations, elements, components and/or groups thereof. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

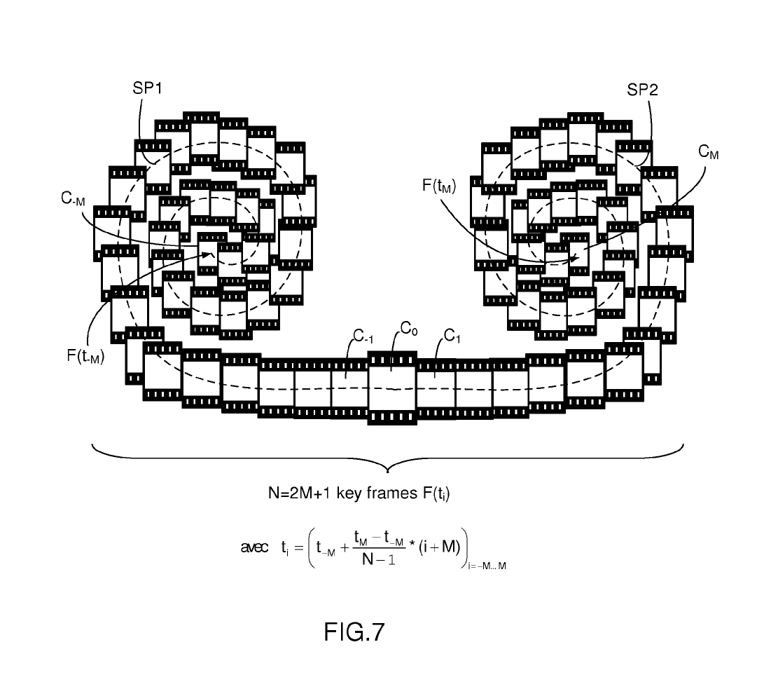

The invention will be described hereinafter by using a user interface layout having N=2M+1 cells Cᵢ disposed along a time line as illustrated by FIG. 7, with iε[−M . . . +M]. This user interface is used for browsing a video sequence of P video frames each having a timestamp, with N<P. Among the 2M+1 cells, the M+1^{th} cell along the time line is defined as the current cell, the M cells before the current cell are defined as past cells and the M cells after the current cell are defined as future cells.

In this figure, the first M cells along the time line (past cells) defines a first spiral SP1 of cells and the last M cells (future cells) defines a second spiral SP2 of cells, these first and second spirals of cells being linked to both sides of the current cell. The current cell is referenced C₀, the past cells are referenced Cᵢ with iε[−M . . . −1] and the future cells are referenced Cᵢ with iε[1 . . . +M].

Of course, other geometries of 1-D or 2-D layout with cells disposed along a time line may be used for the user interface without departing from the scope of the invention. Likewise, cells do not have necessarily the same size and this size can vary according to the position of the cell. In the example of FIG. 7, the size of the cells of each spiral is decreasing towards the center of the spiral and the current cell C₀ has the biggest size.

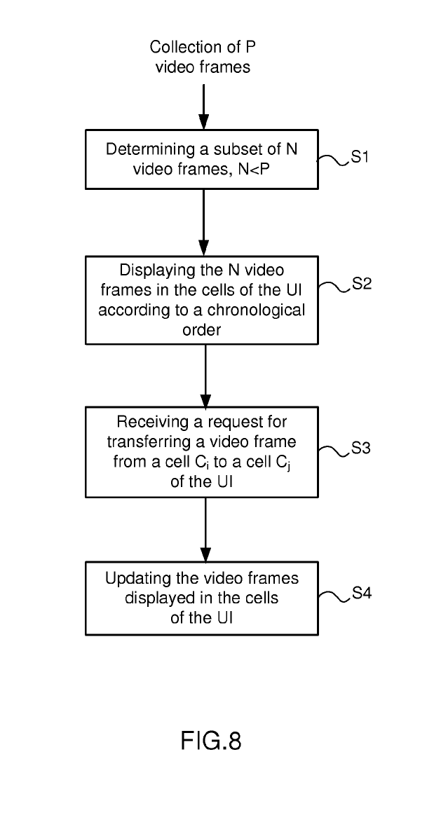

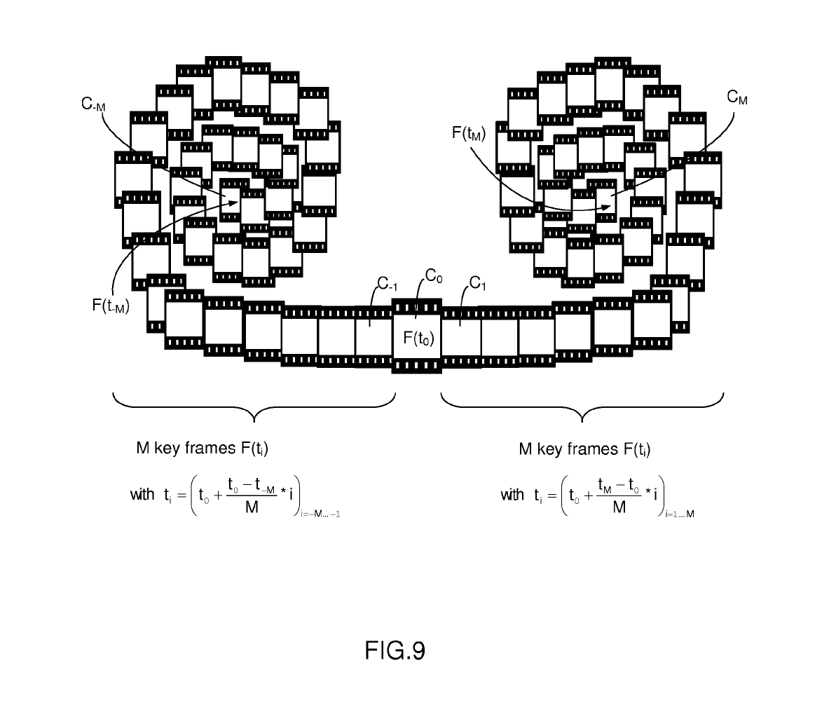

According to the invention and as illustrated by FIG. 8, the method for browsing the video sequence (comprising P video frames) comprises first a step S1 for determining a subset of N key frames representative of the collection, the N key frames being non consecutive video frames of the video sequence. In a step S2, thumbnails of the N video frames are displayed in the N cells of the user interface according to a chronological order.

In a particular embodiment, the step S1 is implemented by subsampling the video sequence. Advantageously, the temporal distance between two successive video frames of the N video frames is substantially constant (the subsampling interval is thus fixed).

This embodiment is illustrated by FIG. 7. N=2M+1 key frames are selected from the video sequence comprising P video frames by subsampling the video sequence with a subsampling step

$$δ = \frac{{t}_{M} - {t}_{- M}}{N}$$

(also called first subsampling interval) where t_{-M} and t_{M} designate the timestamp of the first and last video frames displayed in the cells C_{-M} and C_{M}. The key frames F(tᵢ) are displayed in the cells Cᵢ with

$${t}_{i} = {( {t}_{- M} + \frac{{t}_{M} - {t}_{- M}}{N - 1} * ( i + M ) )}_{i = - M … M} .$$

In a variant illustrated by FIG. 9, the N key frames displayed in the N cells Cᵢ are determined by:
selecting a key frame F(t₀) to be placed into the current cell C₀, and
subsampling the portion of the video sequence preceding the selected key frame and subsampling a portion of the video sequence subsequent to the selected key frame in order to have N−1 key frames to be displayed in the past cells and the future cells.

In this case illustrated by FIG. 9. the east cells Cᵢ (iε[−M . . . −1]) are filled with the key frames F(tᵢ) with

$${t}_{i} = {( {t}_{0} + \frac{{t}_{0} - {t}_{- M}}{M} * i )}_{i = - M … - 1}$$

and the future cells Cᵢ (iε[1 . . . M]) are filled with the key frames F(tᵢ) with

$${t}_{i} = {( {t}_{0} + \frac{{t}_{M} - {t}_{0}}{M} * i )}_{i = 1 … M} .$$

In this embodiment, the portion of the video sequence preceding the key frame F(t₀) is subsampled by a subsampling step

$${δ}_{1} = \frac{{t}_{0} - {t}_{- M}}{M}$$

(also called fourth subsampling interval) for determining the key frames to be displayed in the past cells C_{-M} . . . C₋₁ and the portion of the video sequence subsequent to the key frame F(t₀) is subsampled by a subsampling step

$${δ}_{2} = \frac{{t}_{M} - {t}_{0}}{M}$$

(also called fifth subsampling interval) for determining the key frames to be displayed in the future cells C₁ . . . C_{M}.

In reference to FIG. 8, the method of the invention comprises also the step S3 of receiving an input command requesting to transfer a selected video frame displayed in a cell Cᵢ to a cell Cⱼ of the user interface, the cells Cᵢ and Cⱼ being distinct. Different input commands to the user interface may be used to modify the content of the current cell C₀ or other cells and to stretch (zoom-in) or compress (zoom-out) portions of the video displayed in the cells.

In response to this input command, the method of the invention comprises a step S4 (FIG. 8) for updating the key frame displayed in the cell Cⱼ by the selected key frame and for updating the key frames displayed in at least the cell Cᵢ and the cells comprised between the cell Cᵢ and the cell Cⱼ, by key frames of the collection while maintaining the chronological order of the key frames in the N cells.

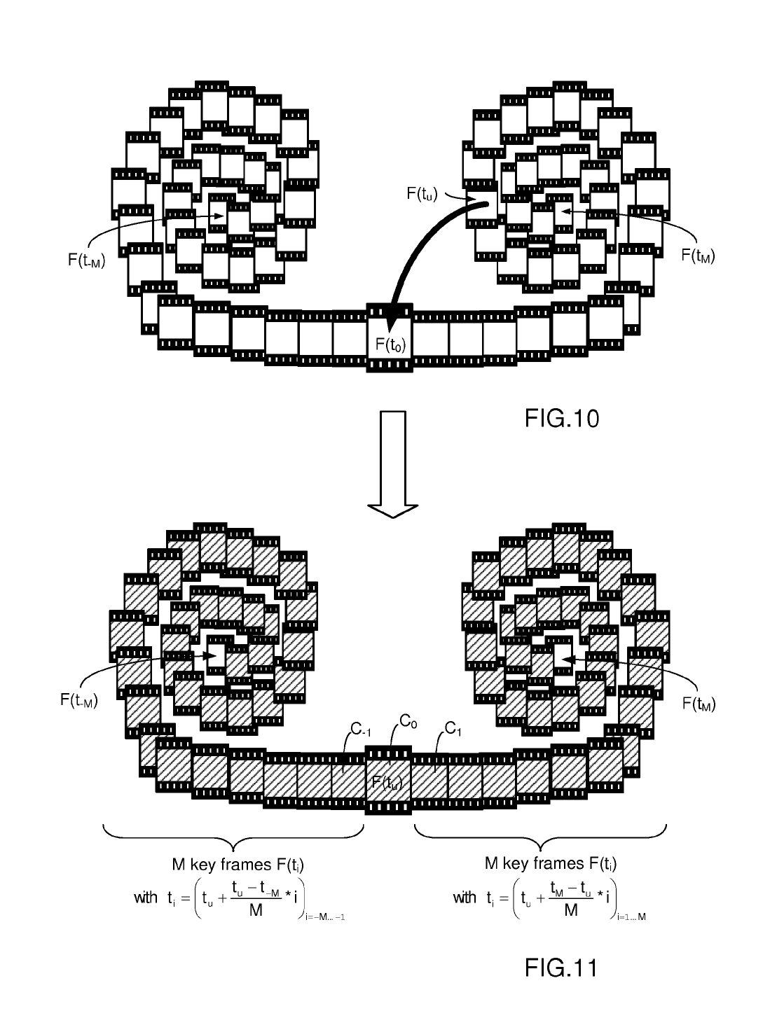

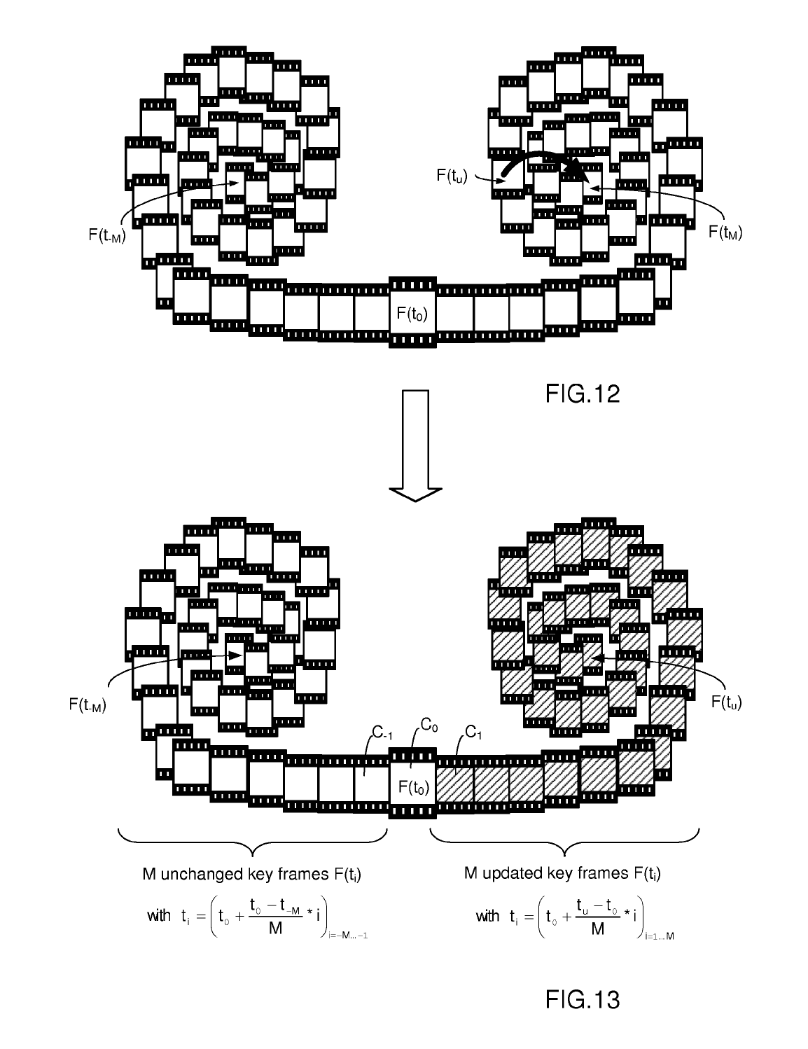

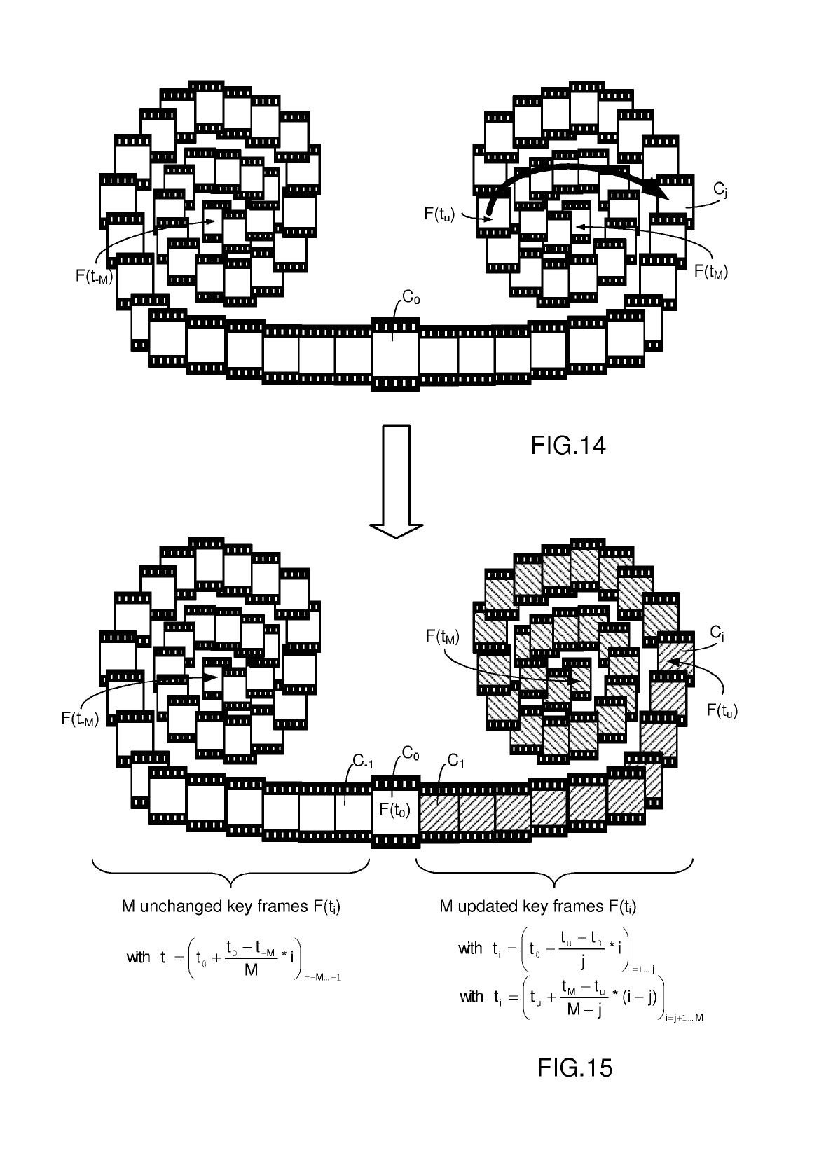

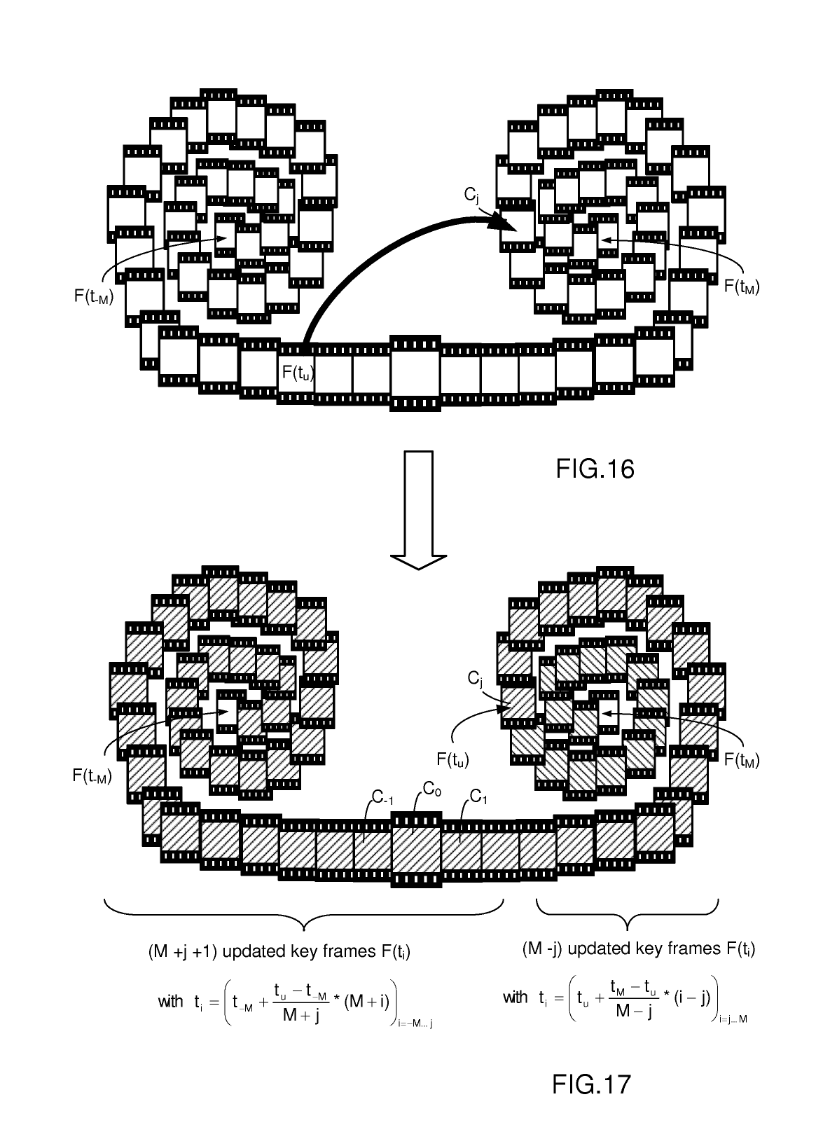

Examples of input commands will be described hereinafter in reference to FIG. 10, FIG. 12, FIG. 14 and FIG. 16 and the update operations in response to these interactions will be described hereinafter in reference to FIG. 11, FIG. 13, FIG. 15 and FIG. 17. These input commands may be entered by moving the cursor of a mouse on the screen displaying the user interface. In a variant, they are entered by moving a finger on a tactile screen displaying the user interface.

FIG. 10 illustrates the case where the user wants to put a key frame F(tᵤ) displayed by one future cell into the current cell C₀. This interaction can be realized by clicking/touching the thumbnail of the key frame F(tᵤ) and dragging it onto the cell C₀.

In that case, the key frames F(tᵢ) displayed in the cells Cᵢ are updated as illustrated by FIG. 11. The key frame F(tᵤ) is displayed in the cell C₀. The key frames F(tᵢ) with

$${t}_{i} = {( {t}_{u} + \frac{{t}_{u} - {t}_{- M}}{M} * i )}_{i = - M … - 1}$$

are displayed in the past cells Cᵢ (iε[−M . . . −1]) and the key frames F(tᵢ) with

$${t}_{i} = {( {t}_{u} + \frac{{t}_{M} - {t}_{u}}{M} * i )}_{i = 1 … M}$$

are displayed in the future cells Cᵢ (iε[1 . . . M]). The hatched cells indicate the cells in which the video key is updated.

It creates a zooming-in (stretching) effect in the future spiral (future cells) since the same number of key frames (M key frames) is used to describe less time (t_{M}-tᵤ instead of t_{M}-t₀). Hence, more temporal details on what happens between instants tᵤ and t_{-M} are revealed in the future spiral. Conversely, it creates a zooming-out (compressing) effect in the past spiral (past cells) since the same number of key frames (M video frames) is used to describe more time (tᵤ-t_{-M} instead of t₀-t_{-M}). Accordingly, in this embodiment, the portion of the video sequence preceding the key frame F(tᵤ) is subsampled by a subsampling step

$${δ}_{1} = \frac{{t}_{u} - {t}_{- M}}{M}$$

(also called second subsampling interval) for determining the key frames to be displayed in the past cells C_{-M} . . . C₋₁ and the portion of the video sequence subsequent to the key frame F(tᵤ) is subsampled by a subsampling step

$${δ}_{2} = \frac{{t}_{M} - {t}_{u}}{M}$$

(also called third subsampling interval) for determining the key frames to be displayed in the future cells C₁ . . . C_{M}.

FIG. 12 illustrates the case where the user wants to zoom-in between the key frame F(t₀) displayed in the current cell C₀ and the video frame F(tᵤ) displayed in one cell of one of the two spirals, for example the future spiral. This interaction can be realized by clicking/touching the thumbnail of the key frame F(tᵤ) and dragging it onto a cell closer to the center of the future spiral. In FIG. 12, the thumbnail of the key frame F(tᵤ) is dragged onto the cell displaying the key frame F(t_{-M}).

In that case, the key frames F(tᵢ) displayed in the cells Cᵢ are updated as illustrated by FIG. 13. The key frame F(tᵤ) is displayed in the cell C_{M}. The key frames F(tᵢ) displayed in the past cells are unchanged and the key frames F(tᵢ) with

$${t}_{i} = {( {t}_{0} + \frac{{t}_{u} - {t}_{0}}{M} * i )}_{i = 1 … M}$$

are displayed in the future cells Cᵢ (iε[1 . . . M]). The subsampling step of the future spiral is reduced

$$( \frac{{t}_{u} - {t}_{0}}{M} < \frac{{t}_{M} - {t}_{0}}{M} ) ,$$

which provides the temporal zoom effect. To zoom out, the user may touch the key frame of the future spiral and drag it out of the spiral, then the key frame F(t_{M}) will be re-set at the center of the spiral.

This action allows to reveal more temporal details on what happens between the key frame F(t₀) and the key frame F(tᵤ).

FIG. 14 illustrates the case where the user wants to zoom-out (compress) between the key frame F(t₀) displayed in the current cell C₀ and the key frame F(tᵤ) displayed in one cell of the future spiral and zoom-in (stretch) between the key frame F(tᵤ) and the last key frame F(t_{M}) displayed in the last cell of the future spiral. This interaction can be realized by clicking/touching the thumbnail of the key frame F(tᵤ) and dragging it onto a future cell Cⱼ more distant to the center of the future spiral (or closer to the center cell C₀).

In that case, the key frames F(tᵢ) displayed in the cells Cᵢ are updated as illustrated by FIG. 15. The key frame F(tᵤ) is displayed in the cell Cⱼ. The key frames F(tᵢ) displayed in the past cells are unchanged and the key frames F(tᵢ) with

$${t}_{i} = {( {t}_{0} + \frac{{t}_{u} - {t}_{0}}{j} * i )}_{i = 1 … j}$$

are displayed in the future cells Cᵢ (iε[1 . . . j]) and the key frames F(tᵢ) with

$$t = {( {t}_{u} + \frac{{t}_{M} - {t}_{u}}{M - j} * ( i - j ) )}_{i = j + 1 … M}$$

are displayed in the future cells Cᵢ (iε[j+1 . . . M]).

Two different subsampling steps δ₁ and δ₂ are then used inside the future spiral.

$${δ}_{1} = \frac{{t}_{u} - {t}_{0}}{j}$$

(also called second subsampling interval in this embodiment) is applied to the j first key frames and

$${δ}_{2} = \frac{{t}_{M} - {t}_{u}}{M - j}$$

(also called third subsampling interval in this embodiment) is applied to the M-j last key-frames.

Given k (1≦k<M and k≠j) the index of the cell containing the key frame F(tᵤ) before user interaction, j>k corresponds to using more key frames to represent the time interval [symbol] t₀,tᵤ [symbol] while using less key frames to represent the time interval [symbol] tᵤ,t_{M} [symbol] , i.e. stretching the representation of the time interval [symbol] t₀,tᵤ [symbol] while compressing the representation of the time interval [symbol] tᵤ,t_{M} [symbol] .

On the contrary, j<k corresponds to using less key frames to represent [symbol] t₀,tᵤ [symbol] while using more key-frames to represent [symbol] tᵤ,t_{M} [symbol] , i.e. compressing the representation of the time interval [symbol] t₀,tᵤ [symbol] while stretching the representation of the time interval [symbol] tᵤ,t_{M} [symbol] .

FIG. 16 illustrates the case where the user wants to put a key frame F(tᵤ) of the past spiral into a cell of the future spiral in order to zoom-in (stretch) the time interval [symbol] t_{-M},tᵤ [symbol] . This interaction can be realized by clicking/touching the thumbnail of the key frame F(tᵤ) and dragging it onto a cell Cⱼ of the future spiral.

In that case, the key frames F(tᵢ) displayed in the cells Cᵢ are updated as illustrated by FIG. 17. The key frame F(tᵤ) is displayed in the cell Cⱼ. The key frames F(tᵢ) with

$${t}_{i} = {( {t}_{- M} + \frac{{t}_{u} - {t}_{- M}}{M + j} * ( M + i ) )}_{i = - M … j}$$

are displayed in the cells Cᵢ (iε[−M . . . j]) and the key frames F(tᵢ) with

$${t}_{i} = {( {t}_{u} + \frac{{t}_{M} - {t}_{u}}{M - J} * ( i - j ) )}_{i = j … M}$$

are displayed in the future cells Cᵢ (iε[j+1 . . . M]). Accordingly, two different subsampling steps δ₁ and δ₂ are then used inside the whole spiral.

$${δ}_{1} = \frac{{t}_{u} - {t}_{- M}}{M + j}$$

(also called second subsampling interval in this embodiment) is applied to the j first key frames and

$${δ}_{2} = \frac{{t}_{M} - {t}_{u}}{M - j}$$

(also called third subsampling interval in this embodiment) is applied to the M-j last key-frames.

Of course, other interactions by dragging the key frame of a cell onto any other cell of the spirals are possible. The update operation can be applied to the cells of only one spiral (e.g. FIG. 13 and FIG. 15) or to cells of the two spirals (e.g. FIG. 11 and FIG. 17). The present user interface may also be used in conjunction with a video player in order to play a video from a given instant. In that case, the user may do it by double clicking on the cell displaying the video frame associated to the given instant. The video frame associated to the given instant is then transferred to cell C0 and the other cells of the user interface or a part of them are updated.

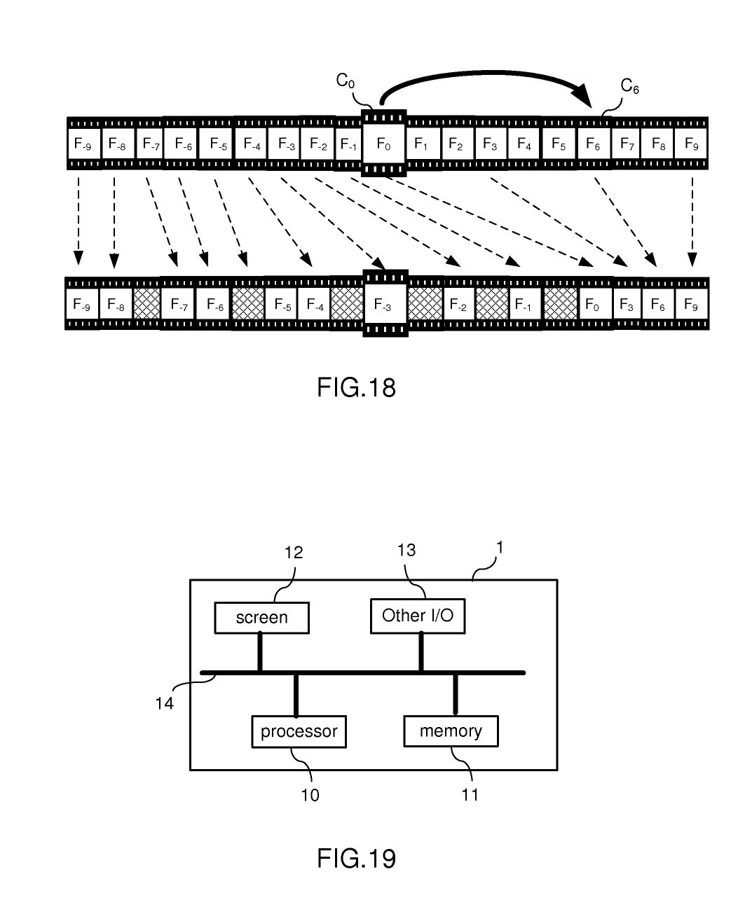

In some cases, it may be a bit disturbing for the user to see that the key frames of all the cells change as soon as the key frame of the current cell changes and not to see the previously displayed key frames anymore. To address this problem, it is proposed to, when zooming-in in a zone of cells, select the updating key frames among the key frames previously displayed in the cells of this zone, redistribute them linearly in this zone and to fill the empty cells by new key-frames selected from the video sequence by using a uniform subsampling. When zooming-out in a zone of cells, it is proposed to select the updating some key frames among the key frames previously displayed in this zone and to redistribute them linearly in the cells of the zone. This update operation is illustrated by FIG. 18.

FIG. 18 shows 19 cells wherein 19 key frames are displayed. For the sake of simplification, the indexing of the key frames is simplified. The key frames displayed in the cells Cᵢ are referenced Fᵢ, iε[−9 . . . +9]. The user puts the frame F₀ in the cell C₆ in order to zoom-in the portion of the displayed video sequence between the key frames F₋₉ and F₀. The update operation consists in keeping the key frames F₋₉ to F₀ and redistributing them in the cells C₋₉ to C₆. Conversely, the portion of the displayed video sequence between the key frames F₀ and F₉ is zoomed-out (compressed). Only the key frames F₃, F₆ and F₉ are kept and displayed in the cells C₇, C₈ and C₉.

All the examples given hereinabove are described where key frames and updating key frames are selected automatically using subsampling in time. Alternative solutions may be used for selecting the key frames such as a selection based on saliency, on detection of faces, cuts or shots in the video sequence. For example, Q frames can be selected among P frames of a video sequence, with Q<P, based on a saliency criterion. N key frames are selected among the Q frames in order to be displayed in the N cells of the user interface. When a transfer of a key frame from a cell Cᵢ to a cell Cⱼ is requested, the updating key frames are selected among the Q frames. For example, if there are K key frames to be updated, the K updating key frames can be selected by subsampling a portion of the Q frames, said portion being related to the part of the video sequence comprising key frames to be updated. In that case, this is not a time subsampling.

Likewise, the invention has been described hereinabove for browsing a video sequence. It can also be used for browsing other collections of frames, for example a collection of reference frames, each reference frame being representative of a own video sequence having a creation date, said creation date being used as timestamp for the reference frame. In that case, the key frames are selected by subsampling the collection of reference frames. The key frames are then displayed in the cells of the user interface in a chronological order by using the associated creation date.

FIG. 19 represents an exemplary architecture of the processing device 1 according to a specific and non-limitative embodiment of the invention. The processing device 1 comprises one or more processor(s) 10, which is(are), for example, a CPU, a GPU and/or a DSP (English acronym of Digital Signal Processor), along with an internal memory 11 (e.g. RAM, ROM, EPROM). The processing device 1 comprises one screen 12 to display the user interface and other Input/Output circuit(s) 13, such as a mouse, a keyboard, a touchpad, adapted to allow a user entering input commands and/or data. The input commands can also be entered by a tactile screen. The processing device 1 may also comprise network interface(s) (not shown). All these circuits communicate through a bus 14.

The internal memory 11 stores a computer program comprising instructions which, when executed by the processing device 1, in particular by the processor 10, make the processing device 1 carry out the processing method described in FIG. 8. As a variant, the computer program is stored externally to the processing device 1 on a non-transitory digital data support, e.g. on an external storage medium such as a HDD, CD-ROM, DVD, a read-only and/or DVD drive and/or a DVD Read/Write drive, all known in the art. The processing device 1 thus comprises an interface to read the computer program. The processing device 1 may also access one or more Universal Serial Bus (USB)-type storage devices (e.g., “memory sticks.”) through corresponding USB ports (not shown).

According to exemplary and non-limitative embodiments, the processing device 1 is a device, which belongs to a set comprising:
a mobile device;
a communication device;
a game device;
a tablet (or tablet computer);
a laptop;
a still picture camera; and
a video camera;

According to the invention, the processor is configured to implement the following steps:
determine a subset of N video frames representative of the collection, said N video frames being non consecutive frames of the collection,
display, on the screen element, the N video frames in the N cells of the user interface according to a chronological order, one of the N cells being defined as a current cell and the cells before and after the current cell along the time line being called past cells and future cells respectively,
receive, from the input circuit, an input command requesting to transfer a selected video frame displayed in a cell Cᵢ to a cell Cⱼ of the user interface, the cells Cᵢ and Cⱼ being distinct,
in response to the input command, update the video frame displayed in the cell Cⱼ by the selected video frame and update the video frames displayed in at least the cell Cᵢ and the cells comprised between the cell Cᵢ and the cell Cⱼ, by video frames of the collection while maintaining the chronological order of the video frames in the N cells, at least one of the updating video frames being not included in the subset of N video frames.

1. Method for browsing a collection of P video frames through a user interface, wherein each video frame has a timestamp and wherein the user interface comprises N cells disposed along a time line with N<P, said method comprising the steps of:
determining a subset of N key frames among the collection of video frames by subsampling the collection of P video frames with a first subsampling interval,
displaying the N key frames in the N cells of the user interface according to a chronological order, one of the N cells being defined as a current cell and the cells before and after the current cell along the time line being called past cells and future cells respectively,
receiving an input command requesting to transfer a selected key frame displayed in a cell Cᵢ to a cell Cⱼ of the user interface, the cells Cᵢ and Cⱼ being distinct,
in response to the input command, updating the key frame displayed in the cell Cⱼ by the selected key frame and updating the key frames displayed between the first cell and the cell Cⱼ by subsampling the collection of video frames comprised between the first frame and the selected key frame with a second subsampling interval and updating the key frames displayed between the cell Cⱼ and the last cell by subsampling the collection of video frames between the selected key frame and the last frame with a third subsampling interval.

2. Method according to claim 1, wherein, in response to the input command:
if the cells Cᵢ and Cⱼ are both past cells, only the key frames displayed in the past cells and the current cell are updated and the third subsampling interval is determined between the selected key frame and the frame in the current cell;
if the cells Cᵢ and Cⱼ are both future cells, only the key frames displayed in the future cells and the current cell are updated and the second subsampling interval is determined between the frame in the current cell and the selected key frame.

3. Method according to claim 1, wherein the first cell and the last cell are not updated.

4. Method according to claim 1, wherein, the collection of P video frames is a video sequence.

5. Method according to claim 1, wherein the N key frames displayed in the N cells are determined by:
selecting a key frame of the collection to be placed into the current cell, and
subsampling the portion of the video sequence preceding the selected key frame with a fourth subsampling interval and subsampling a portion of the video sequence subsequent to the selected key frame with a fifth subsampling interval in order to determine N−1 updating key frames to be displayed in the past cells and the future cells.

6. Method according to claim 5, wherein the temporal distance between two frames displayed in two consecutive cells of the past cells or the future cells is substantially constant.

7. Method according to claim 5, wherein the N key frames displayed in the N cells are determined by selecting N key frames in the video sequence based on a saliency criterion or on the presence of faces or on the presence of cuts in the video sequence.

8. Method according to claim 7, wherein the N key frames are selected among Q key frames determined according said predetermined selection criterion, with N<Q<P, and, when a transfer of a key frame from a cell Cᵢ to a cell Cⱼ is requested, the updating key frames are selected among the Q frames.

9. Method according to claim 1, wherein the user interface comprises N=2M+1 cells, one cell for the current cell, M cells for the past cells and M cells for the future cells.

10. Method according to claim 9, wherein the cells are disposed along the time line such the first M cells defines a first spiral of cells and the last M cells defines a second spiral of cells, said first and second spirals of cells being linked to both sides of the current cell.

11. Device for browsing a collection of P video frames through a user interface, wherein each video frame has a timestamp and wherein the user interface comprises N cells disposed along a time line with N<P, said processing device comprising a processor for processing said P video frames, a display element for displaying said user interface, an input circuit for receiving input commands, the processor being configured to:
determine a subset of N key frames among the collection of P video frames by subsampling the collection of P video frames with a first subsampling interval,
display, on the screen element, the N video frames in the N cells of the user interface according to a chronological order, one of the N cells being defined as a current cell and the cells before and after the current cell along the time line being called past cells and future cells respectively,
receive, from the input circuit, an input command requesting to transfer a selected video frame displayed in a cell Cᵢ to a cell Cⱼ of the user interface, the cells Cᵢ Cⱼ and being distinct,
in response to the input command, update the video frame displayed in the cell Cⱼ by the selected video frame and update the video frames displayed between the first cell and the cell Cⱼ by subsampling the collection of video frames comprised between the first frame and the selected key frame with a second subsampling interval and updating the key frames displayed between the cell Cⱼ and the last cell by subsampling the collection of video frames between the selected key frame and the last frame with a third subsampling interval.

12. The device according to claim 11, wherein, in response to the input command:
if the cells Cᵢ and Cⱼ are both past cells, only the key frames displayed in the past cells and the current cell are updated and the third subsampling interval is determined between the selected key frame and the frame in the current cell;
if the cells Cᵢ and Cⱼ are both future cells, only the key frames displayed in the future cells and the current cell are updated and the second subsampling interval is determined between the frame in the current cell and the selected key frame.

13. The device according to claim 11, wherein the first cell and the last cell are not updated.

14. The device according to claim 11, wherein, the collection of P video frames is a video sequence.

15. The device according to claim 11, wherein the N key frames displayed in the N cells are determined by:
selecting a key frame of the collection to be placed into the current cell, and
subsampling the portion of the video sequence preceding the selected key frame with a fourth subsampling interval and subsampling a portion of the video sequence subsequent to the selected key frame with a fifth subsampling interval in order to determine N−1 updating key frames to be displayed in the past cells and the future cells.
